(19) United States
(12) Patent Application Publication
(10) Pub. No.: US 2009/0009436 A1
(43) Pub. Date: Jan. 8, 2009

(54) PLASMA DISPLAY PANEL DEVICE AND DRIVE METHOD THEREOF

(76) Inventors: Keiji Akamatsu, Osaka (JP); Kenji Ogawa, Osaka (JP); Mitsuo Ueda, Hyogo (JP)

Correspondence Address: SNELL & WILMER L.L.P. (Panasonic), 600 ANTON BOULEVARD, SUITE 1400, COSTA MESA, CA, 92626, US

(21) Appl. No.: 11/572,532

(22) PCT Filed: Mar. 17, 2006
(86) PCT No.: PCT/JP2006/005417

§ 371 Date: Sep. 18, 2008

(30) Foreign Application Priority Data
Mar. 25, 2005 (JP) 2005-089953

(51) Int. Cl. G09G 3/28

(52) U.S. Cl. 345/67; 345/60; 315/169.1

(57) ABSTRACT

Provided are a PDP device and a drive method thereof which restrict the generation of an erroneous discharge in the all-cell reset period and to restrict the appearance of flickers in the areas with low grayscale levels even if some areas have a lower firing voltage than the other areas due to variation of a property in the panel surfaces or due to a long-term driving, or even if the voltage applied to the address electrode is increased with the pursuit of high definition.

The pulse Pul.3 is applied to address electrodes Dat at timing t0 prior to timing t1 when the potential of the scan electrodes Scn is increased to Vq(V). In this drive method, voltage Vx(V) is applied to address electrodes Dat so that there is no potential difference between the scan electrodes Scn and the sustain electrodes Sus at timing t0 when discharge Dis.3 is generated. Accordingly, the discharge Dis.3, which is generated between the scan electrodes Scn and the sustain electrodes Sus due to reduction in the firing voltage, does not become a trigger for extending to the scan electrodes Scn to generate an erroneous discharge.

### TECHNICAL FIELD

The present invention relates to a plasma display panel device and a drive method thereof, and specifically relates to a technology for restricting an erroneous discharge from occurring during a reset period when the device is driven.

### BACKGROUND ART

Plasma display panels (hereinafter referred to as PDPs), especially the AC surface-discharge type PDPs, have a construction in which two panels are arranged to face each other with a space therebetween, are sealed at the perimeter, and a discharge gas containing xenon (Xe) and others are filled in the inner space of the sealed panels. One of the two panels (front panel) has a construction in which a plurality of pairs of display electrodes are formed on a main surface of a glass substrate, and a dielectric layer and a protective layer are formed to cover the display electrodes, in the stated order.

The other panel (back panel) has a construction in which a plurality of address electrodes are formed on a main surface that faces the main surface of the glass substrate of the front panel, and a dielectric layer is formed to cover the address electrodes. The back panel is further provided with barrier ribs that are each disposed between adjacent address electrodes to be in parallel with the address electrodes. The barrier ribs function as a member for maintaining the gap between these panels. A phosphor layer having a different color of red, green, or blue is formed between adjacent barrier ribs in each pair. The front panel and the back panel are arranged such that display electrode pairs and the address electrodes intersect.

In PDP devices using a PDP as the display panel, a driver is connected to each electrode, and each driver is connected to a drive control unit that transmits a drive signal in accordance with the sub-field method (the in-field time division gray scale display method). A PDP device is driven such that it reproduces the grayscale by controlling the ON/OFF of each of a plurality of weighted sub-fields constituting one field. Each sub-field includes an address period and a sustain period. In the address period, an address discharge is generated, in each of selected discharge cells, between an address electrode and a scan electrode that is one of display electrodes in a pair. In the sustain period, an alternating voltage is applied to, in all the discharge cells, between a scan electrode and a sustain electrode in each pair such that a sustain discharge is generated in each discharge cell to which addressing has been made (see, for example, Document 1).

Each field includes an all-cell reset period in which a reset discharge is generated in all the discharge cells at once to erase the wall charges that have been made so far in the sub-fields, and to form wall charges for addressing.

It is presumed here that the all-cell reset period is divided into a first step and a second step in time series, as shown in FIG. 1. In the first step, the potential of the sustain electrode and the address electrode is set to 0(V), and a voltage having a rising ramp waveform is applied to the scan electrode such that the potential of the scan electrode gradually rises from Vq(V) to Vr(V). This voltage change generates a weak first reset discharge in which the scan electrode is the anode and the sustain electrode and the address electrode are the cathode. In the second step of the reset period, the potential of the sustain electrode is set to Vh(V), and a voltage having a falling ramp waveform is applied to the scan electrode such that the potential of the scan electrode gradually falls from Vg(V) to Va(V). This voltage change generates a weak second reset discharge in which the scan electrode is the cathode and the sustain electrode and the address electrode are the anode. In the all-cell reset period, the reset of all the discharge cells is achieved by the two weak discharges.

Meanwhile, in recent years, as one method for improving the PDP luminous efficiency, the partial pressure of Xe in the discharge gas is increased. In this case, with use of a conventional drive method as shown in FIG. 1, it becomes prominent that a strong discharge is generated in the first step of the all-cell reset period, and influenced by this, sometimes a strong discharge is generated also in the second step. With the generation of a strong discharge in the all-cell reset period as shown in FIG. 1, a wall discharge is generated. The wall discharge generated here resembles a wall discharge that is generated when an addressing is made, and thus leads to deterioration of images.

The problem of the above-described method is taken into account in another later-developed method in which as shown in FIG. 2, the potential of the address electrode is set to Vx(V) immediately after the potential of the scan electrode is set to Vq(V), in the first step of the all-cell reset period. In this method, a discharge is generated between the scan electrode and the sustain electrode before a discharge is generated between the scan electrode and the address electrode such that the reset discharge is generated in a stable manner (the latter method is referred to as improved conventional technology). This construction is based on the mechanism analysis that the discharge is more stable when the sustain electrode functions as the cathode than when the address electrode functions as the cathode, due to the difference between the protective layer and the phosphor layer in the secondary electron emission coefficient.
Document 1: Japanese Patent Application Publication No. 2000-242224

### DISCLOSURE OF THE INVENTION

### The Problems the Invention is Going to Solve

In PDP devices, however, panel surfaces sometimes happen to include some areas that have a lower firing voltage for starting discharges among the scan, sustain, and address electrodes than the other areas, due to variation of a property in the panel surfaces or due to a long-term driving. This phenomenon becomes prominent when the partial pressure of Xe in the discharge gas is increased. When this happens, even in a PDP device using the improved conventional technology, a strong discharge may be generated in the scan electrode in the first step due to the application of a voltage to the address electrode, and influenced by this, sometimes a strong discharge is generated also in the second step, as shown in FIG. 2.

As understood from the above description, when there is an area having a lower firing voltage than the other areas, the image quality cannot be fully maintained even by the improved conventional technology in which voltage Vx(V) is applied to the address electrode in the first step of the all-cell reset period.

It should also be noted here that in recent years, with the pursuit of high definition in compliance with the full high-vision or the like, there is a tendency that a voltage higher than a voltage adopted in conventional technologies is applied to the address electrode in the address period. This is because with the pursuit of high definition, a discharge interference between adjacent discharge cells increases, and it is necessary to assure that the addressing is made without being influenced by the discharge interference.

When the cost and the circuit structure are taken into account, it is preferable that the voltage Vx(V) that is applied to the address electrode in the first step of the all-cell reset period is set to be equal to the voltage applied to the address electrode in the address period. This indicates that as the voltage applied to the address electrode in the address period is increased as a countermeasure to the discharge interference between adjacent discharge cells, the voltage Vx(V), which is applied to the address electrode in the all-cell reset period, is also increased. When this happens, a discharge is apt to start in the initial stage by the above-described voltage even in areas other than the areas having a lower firing voltage, and the discharge causes a discharge interference at low grayscale levels. Accordingly, the higher the high definition level of the PDP device is, the more apt the PDP device is to have a problem such as appearance of flickers in the areas with low grayscale levels.

The object of the present invention is therefore to provide a plasma display panel device that during the all-cell reset period, restricts an erroneous discharge from occurring and restricts flicker from appearing in areas having low grayscale levels, even if an area having a lower firing voltage than the other areas is generated due to variation of a property in the panel surfaces or due to a long-term driving, and even if the voltage applied to the address electrode is increased with the pursuit of high definition, and to provide a drive method of the plasma display panel device.

### Means to Solve the Problems

The inventors of the present invention analyzed the mechanism of the strong discharge that occurs due to the application of voltage Vx(V) to the address electrode. From the analysis, the inventors of the present invention reached the following finding. That is to say, a discharge is generated between the address electrode and the sustain electrode by voltage Vx(V) applied to the address electrode in an area in which the firing voltage has decreased, as indicated by the reset light emission 2 shown in FIG. 2. At the time when the above-mentioned discharge is generated, there is a difference Vq(V) in potential between the scan electrode and the sustain electrode. Under this condition, the above-mentioned discharge becomes a trigger to generate a discharge even on the scan electrode side, and the discharge develops into a strong discharge.

Based on the above-stated finding, the object of the present invention is fulfilled by the following constructions.

A drive method of a plasma display panel device which includes a panel unit in which a plurality of pairs of first electrode and second electrode are arranged and also a plurality of third electrodes are arranged to intersect the first and second electrode pairs with a discharge space therebetween, discharge cells being provided in one-to-one correspondence with three-dimensional intersections of the third electrodes and the first and second electrode pairs, wherein each field in a time domain is divided into a plurality of brightness-weighted sub-fields and includes an all-cell reset period in which all of the discharge cells are reset with respect to wall charge state, wherein the all-cell reset period is divided into a period first step and a period second step, a voltage having a ramp waveform with a positive slant is applied to first electrodes in the period first step to generate a first reset discharge, and a voltage having a ramp waveform with a negative slant is applied to the first electrodes in the period second step to generate a second reset discharge, and a voltage having a waveform of a positive polarity relative to second electrodes is applied to the third electrodes in the period first step at a timing prior to generation of the first reset discharge.

More specifically, the following two methods and a combination of the methods may be adopted:

(1) the waveform of the voltage applied to the third electrodes in the period first step includes a rising ramp waveform portion with a positive slant; and

(2) with respect to the waveform of the voltage applied to the third electrodes in the period first step, a timing at which the rising ramp waveform portion starts is set to be prior to a timing at which a rising ramp waveform portion in the waveform of the voltage applied to the first electrodes starts.

The PDP device of the present invention is characterized in that the drive unit drives the panel unit to perform a display by the above-stated drive method.

### EFFECTS OF THE INVENTION

In the PDP device and the drive method thereof of the present invention, a voltage having a waveform of a positive polarity relative to second electrodes is applied to the third electrodes in the period first step at a timing prior to generation of the first reset discharge. With this construction of the PDP device and the drive method thereof of the present invention, even if some areas have a lower firing voltage than the other areas due to variation of a property in the panel surfaces, a discharge that is strong enough to influence the address period and the sustain period is not generated in the period first step of the all-cell reset period. More specifically, any of the above-described two methods (1) and (2) and a combination of the methods may be adopted.

When, for example, the above-described method (1) is adopted, a ramp waveform is applied to the rising portion. With this construction, if a discharge is generated between the third electrodes and the second electrodes by a voltage applied to the third electrodes, the generated discharge is only a weak discharge and does not extend to the first electrodes side. As a result, the method of the present invention can effectively restrict the generation of a discharge that is strong enough to extend to the first electrodes in the period first step in the all-cell reset period and to influence the address period. Accordingly, with the adoption of the method of the present invention, even if panel surfaces include some areas that have a lower firing voltage than the other areas due to variation of a property in the panel surfaces or due to a long-term driving, it is possible to effectively restrict the generation of an erroneous discharge in the all-cell reset period. It should be noted here that the ramp waveform is described in detail in “ASIA DISPLAY '98, pp. 23-27” and the like, and the slant of the waveform is described in detail in Japanese Patent Publication No. 3394010 (for example, 9V/μ sec.) and the like, and that description of these terms is omitted here.

The above-described method (1) makes it possible to restrict the generation of an erroneous discharge if the application of the voltage to the third electrodes in the period first step is performed at the same time of after the application of the voltage to the first electrodes. This construction produces an advantageous effect of eliminating the need to ensure an excessive amount of withstanding voltage for the address driver in relation to the wringing by the potential change in the third electrodes, as well as the effect of restricting the generation of an erroneous discharge in the all-cell reset period. Accordingly, with the adoption of the present method, it is possible to reduce the cost for the whole device cost as a whole.

In the above-described method (1), it is preferable, in terms of restricting the generation of an erroneous discharge, that a slant of the rising ramp waveform portion in the waveform of the voltage applied to the third electrodes in the period first step is set to be slower than a slant of a rising portion in a waveform of the voltage applied to the third electrodes in the address period.

When the above-described method (2) is adopted, a voltage is applied to the third electrodes at a timing prior to a timing when a voltage starts to be applied to the first electrodes. With this construction, if a discharge is generated between the third electrodes and the second electrodes by a voltage applied to the third electrodes, since there is no potential difference between the first electrodes and the second electrodes at the time when the discharge is generated, the discharge does not become a trigger for developing into a strong discharge. Accordingly, with the adoption of the present method, even if panel surfaces include some areas that have a lower firing voltage than the other areas due to variation of a property in the panel surfaces or due to a long-term driving, it is possible to restrict the generation of an erroneous discharge in the all-cell reset period.

In the above-described method (2), it is preferable that the timing at which the rising ramp waveform portion in the waveform of the voltage applied to the third electrodes starts is set with a predetermined time period before the timing at which the rising portion in the waveform of the voltage applied to the first electrodes starts such that even if a discharge is generated between the third electrodes and the second electrodes by the application of the voltage to the third electrodes, an influence of the discharge generated between the third electrodes and the second electrodes attenuates within the predetermined time period.

In the above-described methods (1) and (2), it is preferable to set the waveform such that at a timing when the period second step starts, a voltage starts to be applied to second electrodes, and a falling portion in the waveform of the voltage applied to the third electrodes starts.

In the above-described methods (1) and (2), it is preferable that with respect to the waveform of the voltage applied to the third electrodes in the period first step, an amplitude of the waveform is set based on at least one of a drive time period and a panel temperature. With this construction, it is possible to generate a stable reset discharge taking into account unstable discharge factors such as the drive time period and the panel temperature. For example, it is possible to set the amplitude of the waveform of the voltage applied to the third electrodes to be larger as the drive time period becomes longer.

In the above-described methods (1) and (2), it is preferable that each field is composed of one or more first sub-fields that include the all-cell reset period and one or more second sub-fields that do not include the all-cell reset period, and a ratio of the first sub-fields to one field is determined in accordance with an average picture level (APL) for an image corresponding to said one field. The reason is as follows. That is to say, when the APL value is high in a field, it is considered that the image has a narrow black display area. Accordingly, when this happens, the drive method of the present invention increases the number of sub-fields including the all-cell reset period. This construction makes it possible to stabilize the address discharge in the address period and increase the amount of priming to stabilize the discharge. On the other hand, when the APL value is low in a field, it is considered that the image has a wide black display area. Accordingly, when this happens, the drive method of the present invention decreases the number of sub-fields including the all-cell reset period to improve the black display quality.

The PDP device and the drive method thereof of the present invention may adopt a construction in which with respect to the waveform of the voltage applied to the third electrodes in the period first step, a timing at which a potential changes is set based on at least one of a drive time period and a panel temperature. Also, the PDP device and the drive method thereof of the present invention may adopt a construction in which with respect to the waveform of the voltage applied to the third electrodes in the period first step, a timing at which the waveform becomes “High” is set in accordance with the APL. Also, the PDP device and the drive method thereof of the present invention may adopt a construction in which with respect to the waveform of the voltage applied to the third electrodes in the period first step, an amplitude of the waveform is set in accordance with the APL.

Further, the PDP device and the drive method thereof of the present invention is effective when the panel unit is applied to a device that has a resolution higher than “HD”. That is to say, even if the voltage applied to the address electrode is increased with the pursuit of high definition, the PDP device and the drive method thereof of the present invention can restrict the generation of a discharge if a (High) voltage is applied to the address electrodes in the all-cell reset period. Accordingly, the PDP device and the drive method thereof of the present invention can prevent the appearance of flickers in the areas with low grayscale levels, even with high definition displays.

As described above, the PDP device and the drive method thereof of the present invention are, in a reliable manner, able to restrict the generation of an erroneous discharge in the all-cell reset period and to restrict the appearance of flickers in the areas with low grayscale levels even if some areas have a lower firing voltage than the other areas due to variation of a property in the panel surfaces or due to a long-term driving, or even if the voltage applied to the address electrode is increased with the pursuit of high definition.

### BRIEF DESCRIPTION OF THE DRAWING

FIG. 1 is a waveform diagram showing waveforms of the voltages applied to the electrodes Scn, Sus, and Dat during the all-cell reset period, in a conventional drive method of the PDP device.

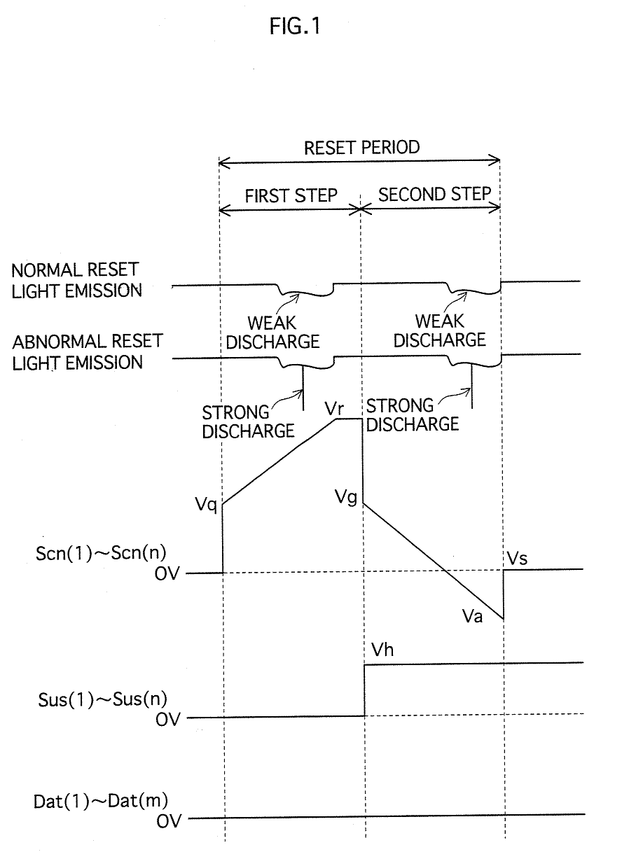

FIG. 2 is a waveform diagram showing waveforms of the voltages applied to the electrodes Scn, Sus, and Dat during the all-cell reset period, in a conventional drive method of the PDP device intended to restrict the generation of erroneous discharges.

FIG. 3 is a main part perspective view (partially sectional view) showing the main part of the panel unit 10, in the construction of the PDP device 1 in Embodiment 1.

FIG. 4 is a block diagram showing the construction of the PDP device 1.

FIG. 5 is a waveform diagram showing waveforms of voltages applied to the electrodes Scn, Sus, and Dat during each of the periods T₁-T₄ when the PDP device 1 is driven.

FIG. 6 is a detailed waveform diagram showing waveforms of voltages applied to the electrodes Scn, Sus, and Dat during the all-cell reset period T₁ when the PDP device 1 is driven.

FIG. 7 is a flowchart showing steps S1-S16 performed by the display drive unit 20 during the all-cell reset period T₁, in the PDP device 1.

FIG. 8 is a schematic diagram showing relationships between the counter values counted by the timing generating unit 24 and the waveforms of voltages applied to the electrodes Scn, Sus, and Dat during the all-cell reset period T₁.

FIG. 9 shows the construction of the sub-fields SF₁ to SF₁₀ in one field for driving the PDP device 1.

FIG. 10 is a detailed waveform diagram showing waveforms of the voltages applied to the electrodes Scn, Sus, and Dat during the all-cell reset period T₅ when the PDP device in Embodiment 2 is driven.

### DESCRIPTION OF CHARACTERS

1 plasma display panel device
10 panel unit
11 front panel
12 back panel
20 display drive unit
21 address driver
22 scan driver
23 sustain driver
24 timing generating unit
25 A/D converter
26 scan number converting unit
27 sub-field converting unit
28 APL detecting unit
111 front substrate
112 display electrode pair
113, 122 dielectric layer
114 protective layer
121 back substrate
123 barrier rib
124 phosphor layer 124
1121, 1122 transparent electrode portion
1123, 1124 bus electrode portion
1231 main barrier rib
1232 sub-barrier rib
Scn scan electrode
Sus sustain electrode
Dat address electrode

### BEST MODE FOR CARRYING OUT THE INVENTION

### Embodiment 1

### 1. Construction of Panel 10

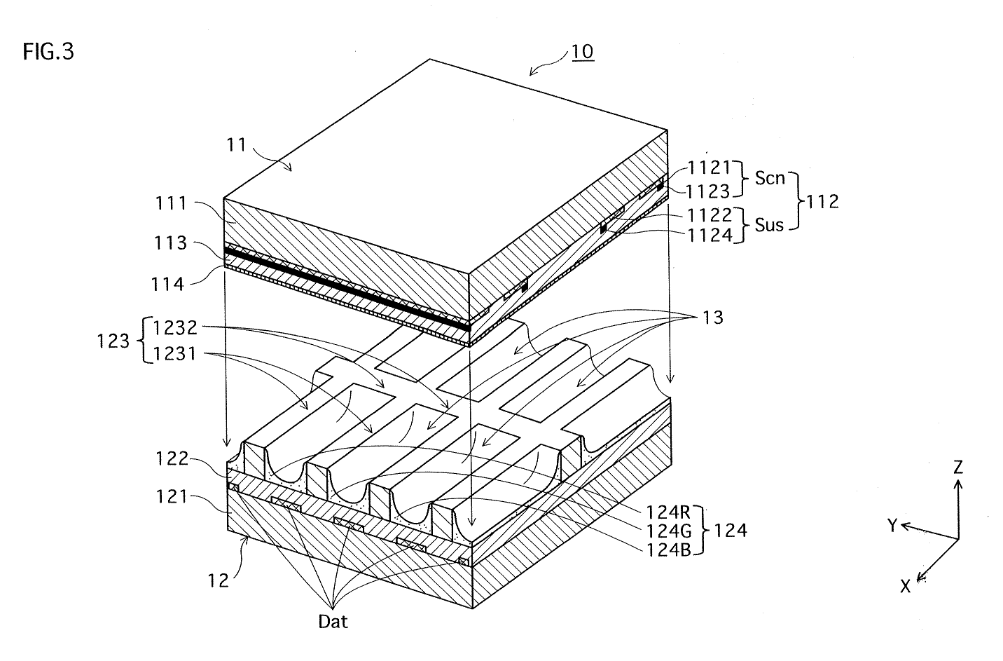

Here, among the constituent elements of a PDP device 1 in Embodiment 1 of the present invention, the construction of a panel unit 10 will be described first, with reference to FIG. 3. FIG. 3 is a main part perspective view (partially sectional view) showing the construction of the panel unit 10 in Embodiment 1.

### 1-1. Construction of Front Panel 11

A front panel 11 is constructed such that a plurality of display electrode pairs 112, each pair being made of scan electrode Scn and sustain electrode Sus, are disposed in parallel with each other on a surface (in FIG. 3, the lower surface) of a front substrate 111 that faces a back panel 12. And a dielectric layer 113 and a protective layer 114 are formed to cover the display electrode pairs 112, in the stated order.

The front substrate 111 is made of, for example, a high-strain-point glass or a soda-lime glass. Each scan electrode Scn is a stack of a transparent electrode portion 1121 and a bus electrode portion 1123; and each sustain electrode Sus is a stack of a transparent electrode portion 1122 and a bus electrode portion 1124. The transparent electrode portions 1121 and 1122 are larger in width than the bus electrode portions 1123 and 1124, and contain ITO (tin-dope indium tin oxide), SnO₂ (tin oxide), and ZnO (zinc oxide). The bus electrode portions 1123 and 1124 are provided with Ag (Silver) and Cr(Chrome)-Cu(Copper)-Cr(Chrome) for decreasing the electric resistance.

The dielectric layer 113 is made of a Pb—B based low-melting glass. The protective layer 114 is mainly made of MgO (magnesium oxide) or MgF₂ (magnesium floride).

It should be noted here that on the surface of the front substrate 111, black stripes may be provided between adjacent display electrode pairs 112 so as to prevent light from leaking to adjacent discharge cells.

### 1-2. Construction of Back Panel 12

A back panel 12 is constructed such that a plurality of address electrodes Dat are disposed in a direction substantially perpendicular to the display electrode pairs 112 on a surface (in FIG. 3, the upper surface) of a back substrate 121 that faces the front panel 11. And a dielectric layer 122 is formed to cover the address electrodes Dat. Further, on the dielectric layer 122, main barrier ribs 1231 are formed to be erected between adjacent address electrodes Dat, and sub-barrier ribs 1232 are formed in a direction substantially perpendicular to the main barrier ribs 1231. In the panel unit 10, the main barrier ribs 1231 and the sub-barrier ribs 1232 constitute barrier ribs 123 of the back panel 12. It should be noted here that although the drawing do not show in detail, the upper end of the sub-barrier ribs 1232 is set to be slightly lower than the upper end of the main barrier ribs 1231 in the z direction.

On the back panel 12, a phosphor layer 124 is provided in each area enclosed by two main barrier ribs 1231 and two sub-barrier ribs 1232. There are three types of phosphor layers 124: phosphor layers 124R with red color; phosphor layers 124G with green color; and phosphor layers 124B with blue color. One of these colors is assigned to the phosphor layers 124 formed in the dent in each row separated by the main barrier ribs 1231. In the example shown in FIG. 3, phosphor layers 124R, 124G, and 124B are formed in turn in each row separated by the main barrier ribs 1231 that extends in the x direction.

The back substrate 121 of the back panel 12 is, as is the case with the front substrate 111, made of a high-strain-point glass, a soda-lime glass or the like. The Dat are made of a metal material such as silver (Ag). The Dat are formed by applying Ag past or the like to the surface of the back substrate 121 by the screen printing. The material of the address electrodes Dat is not limited to Ag, but may be a metal material such as gold (Au), chrome (Cr), copper (Cu), nickel (Ni), or platinum (Pt), or any combination of these materials achieved in a stack of them.

The dielectric layer 122 is, as is the case with the dielectric layer 113 of the front panel 11, basically made of a Pb—B based low-melting glass. However, not limited to this, the dielectric layer 122 may be made of a material that contains aluminum oxide (Al₂O₃) or titanium oxide (TiO₂). The barrier ribs 123 are made of, for example, a lead glass material.

The phosphor layers 124R, 124G, and 124B are made of, for example, the following phosphors, respectively.

The R phosphor may be formed by using one of (Y,Gd)BO₃:Eu, Y₂O₃:Eu, and YVO₃:Eu, or by using a mixture of these.

The G phosphor may be formed by using one of Zn₂SiO₄:Mn, (Y,Gd)BO₃:Tb, and BaAl₁₂O₁₉:Mn, or by using a mixture of these.

The B phosphor may be formed by using one of BaMgAl₁₀O₁₇:Eu, and CaMgSi₂O₆:Eu, or by using a mixture of these.

### 1-3. Arrangement of Front Panel 11 and Back Panel 12

A panel unit 10 is constructed such that the front panel 11 and the back panel 12 are arranged to face each other with the barrier ribs 123, which function as a member for maintaining the gap between these panels, in between, and the display electrode pairs 112 and the Dat are arranged respectively in directions that are substantially perpendicular to each other, and the front panel 11 and the back panel 12 are sealed at the perimeter thereof. With this construction, discharge spaces 13 are formed, enclosed by the front panel 11, the back panel 12, and the barrier ribs 123. Namely, the front panel 11 and the back panel 12 form a sealed container. A discharge gas, being a mixture of Ne, Xe, He and the like is filled in the discharge spaces 13 in the panel unit 10. The charging pressure of the discharge gas is, for example, 50-80 (kPa).

Conventionally, the ratio of the partial pressure of Xe to the total pressure in the discharge gas has been set to less than 7(%). However, in recent years, with the aim of improving the panel light-emission brightness, the partial pressure of Xe in the discharge gas is set to be high as 7(%) or more or 10(%) or more in line with its increasing trend.

In the panel unit 10, three-dimensional intersections of the display electrode pairs 112 and the address electrodes-Dat respectively correspond to the discharge cells (not illustrated), and a plurality of discharge cells are arranged in a matrix.

### 2. Construction of PDP Device 1

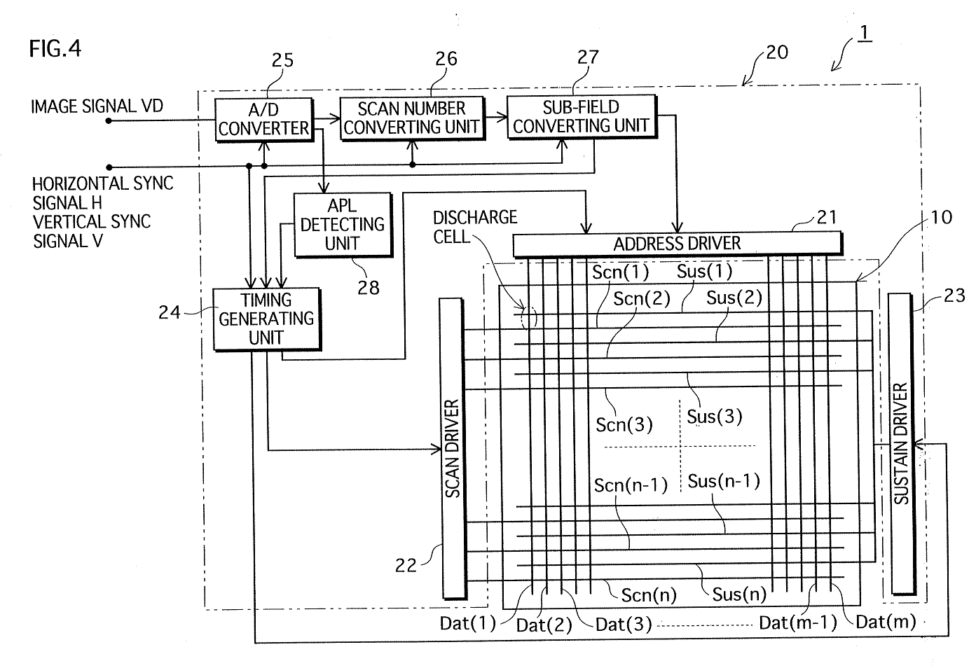

The PDP device 1, which is provided with the panel unit 10 with the above-described construction, will be described with reference to FIG. 4. FIG. 4 is a block diagram showing the construction of the PDP device 1. It should be noted here that in FIG. 4, an arrangement of only the electrodes Scn, Sus, and Dat is shown with respect to the panel unit 10.

As shown in FIG. 4, the PDP device 1 in the present embodiment is composed of the panel unit 10 and a display drive unit 20 that applies a voltage having a predetermined waveform to the electrodes Scn, Sus, and Dat at a predetermined timing. In the panel unit 10, respective electrodes of n scan electrodes Scn(1)-Scn(n) and n sustain electrodes Sus(1)-Sus(n) are arranged alternately in the row direction. Also, in the panel unit 10, m address electrodes Dat(1)-Dat(m) are arranged in the column direction. Each discharge cell is provided at an intersection of an address electrode Datl (l ranges from 1 to m) and a pair of scan electrode Scnk (k ranges from 1 to n) and sustain electrode Susk (k ranges from 1 to n) that are adjacent to each other. The panel unit 10 includes m×n pieces of discharge cells in total.

As shown in FIG. 4, the display drive unit 20 includes an address driver 21, a scan driver 22, and a sustain driver 23. The display drive unit 20 includes a timing generating unit 24, an A/D converter 25, a scan number converting unit 26, a sub-field converting unit 27, and an APL (Average Picture Level) detecting unit 28, as well. It should be noted here that although not shown in the drawing, the display drive unit 20 includes a power circuit, as well. The image signal VD is input to the A/D converter 25. The horizontal sync signal H and the vertical sync signal V are input to the timing generating unit 24, the A/D converter 25, the scan number converting unit 26, and the sub-field converting unit 27.

The A/D converter 25 of the display drive unit 20 converts the input image signal VD into the digital signal representing image data, and outputs the converted image data to the display drive unit 20 and the APL detecting unit 28. The APL detecting unit 28 adds up all the grayscale levels in one screen based on the display screen data which, transferred from the A/D converter 25, indicates each grayscale level of each discharge cell contained in one screen, and obtains a value by dividing the adding up result value by the total number of discharge cells. The APL detecting unit 28 then obtains an average picture level by calculating a percentage of the division result value to the maximum grayscale level (for example, “256”), and outputs the obtained average picture level to the timing generating unit 24. The lower the average picture level is, the darker the screen is; and the higher the average picture level is, the whiter the screen is.

The scan number converting unit 26 converts the image data received from the A/D converter 25 into the image data corresponding to the number of pixels of the panel unit 10, and outputs the converted image data to the sub-field converting unit 27. The sub-field converting unit 27 includes a sub-field memory (not illustrated), and converts the image data received from the scan number converting unit 26 into sub-field data that is a set of pieces of binary data that indicate ON/OFF of a set of sub-fields with respect to each discharge cell, the sub-field data being used for grayscale reproduction in the panel unit 10. The sub-field converting unit 27 temporarily stores the sub-field data in the sub-field memory. The sub-field converting unit 27 then outputs the sub-field data to the address driver 21 in accordance with the timing signal received from the timing generating unit 24.

The address driver 21 converts the image data for each sub-field into a signal which corresponds to each of the address electrodes Dat(1)-Dat(m), so as to drive each address electrode Dat. The address driver 21 is provided with a known driver IC and the like.

The timing generating unit 24 generates a timing signal based on the horizontal sync signal H and the vertical sync signal V, and outputs the generated signal to the address driver 21, the scan driver 22, and the sustain driver 23. Here, the timing generating unit 24, based on the APL value input from the APL detecting unit 28, determines, for each sub-field constituting one field, whether the reset period is the all-cell reset period or the selective reset period, and controls the number of all-cell reset periods in one field.

The scan driver 22 applies a drive voltage to the scan electrodes Scn(1)-Scn(n), based on the timing signal received from the timing generating unit 24. The scan driver 22 is provided with a known driver IC, as is the case with the address driver 21.

The sustain driver 23 also includes a known driver IC, and applies a drive voltage to the sustain electrodes Sus(1)-Sus(n), based on the timing signal received from the timing generating unit 24.

### 3. Method of Driving PDP Device 1

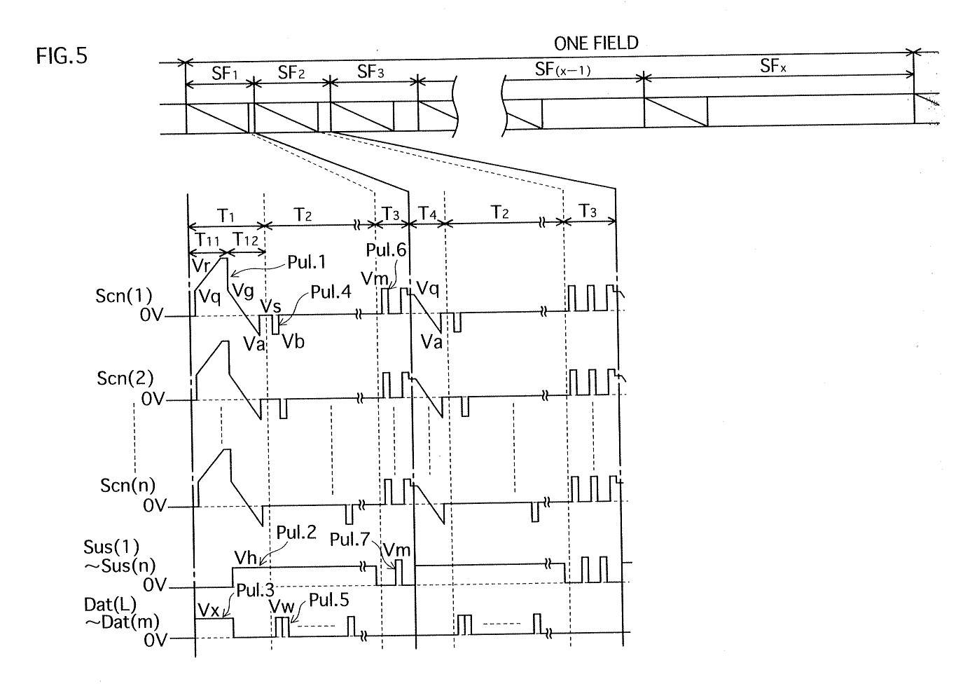

Here will be described how to drive the PDP device 1 having the above-described construction, with reference to FIG. 5.

FIG. 5 shows a method of driving the PDP device 1 using the in-field time division gray scale display method (the sub-field method).

The PDP device 1 is driven as follows. As shown in FIG. 5, one field is divided into X pieces of sub-fields SF₁ to SF_{X}. The number of sustain pulses Pul.6 and Pul.7 is set so that the brightness relative ratio of the sub-fields SF₁-SF_{X} becomes 1:2:4: . . . :2^{(X-1)}. The ON/OFF of each of the sub-fields SF₁-SF_{X} is controlled according to the display brightness data. This enables 2^{(X-1)} grayscale levels to be displayed by combining the X pieces of sub-fields. It should be noted here that although in the present embodiment, 2⁽ⁱ⁻¹⁾ pieces of sustain pulses are assigned to each SFi of the sub-fields SF₁-SF_{X}. The present invention is not limited to this.

As shown in FIG. 5, each of the sub-fields SF₁-SF_{X} includes address period T₂ and sustain period T₃, also includes either all-cell reset period T₁ or selective reset period T₄. The following will describe the all-cell reset period T₂ and the selective reset period T₄, and the address period T₂ and the sustain period T₃.

### 3-1. All-Cell Reset Period T₁

In the all-cell reset period T₁, a reset discharge is generated in all the discharge cells of the panel unit 10 at once to erase the wall charges that have been made so far in the sub-fields SF, and to form wall charges in a distributed state that are required for the address operation during the address period T₂ that follows the period T₁. As shown in FIG. 5, in the all-cell reset period T₁, a reset pulse Pul.1 is applied to the scan electrodes Scn(1)-Scn(n), where the reset pulse Pul.1 includes a slowly rising ramp waveform (a portion with a positive slant from Vq(V) to Vr(V)) and a slowly falling ramp waveform (a portion with a negative slant from Vg(V) to Va(V)). The period including the slowly rising ramp waveform of the reset pulse Pul.1 is defined as a first step T₁₁, and the period including the slowly falling ramp waveform of the reset pulse Pul.1 is defined as a second step T₁₂.

In the first step T₁ of the all-cell reset period T₁, a rectangular wave pulse Pul.3 of the positive polarity having amplitude Vx(V) is applied to the address electrodes Dat(1)-Dat(m). Also, in the first step T₁₁, the potential of the sustain electrodes Sus(1)-Sus(n) is sustained at 0(V).

In the second step T₁₂, a rectangular wave pulse Pul.2 of the positive polarity having amplitude Vh(V) is applied to the sustain electrodes Sus(1)-Sus(n). Also, in the second step T₁₂, the potential of the address electrodes Dat(1)-Dat(m) is sustained at 0(V).

These voltage applications to the electrodes Scn, Sus, and Dat generate a weak first reset discharge in which the scan electrode Scn is the anode and the sustain electrode Sus and the address electrode Dat are the cathode, in the first step T₁₁ of the all-cell reset period T₁; and generate a weak second reset discharge in which the scan electrode Scn is the cathode and the sustain electrode Sus and the address electrode Dat are the anode, in the second step T₁₂. In the all-cell reset period T₁, these two reset discharges erase the wall charges that have been made so far and form wall charges in a distributed state, and also cause the priming (initiator of the discharge=excited particles) to occur, which reduces the discharge delay and stabilizes the address discharge in the address period T₂.

### 3-2. Selective Reset Period T₄

In the present embodiment, the selective reset period T₄ is applied to the sub-fields SF₂. In the selective reset period T₄, reset discharges are generated selectively in discharge cells in which sustain discharges were generated in the immediately preceding sub-field SF.

As shown in FIG. 5, in the selective reset period T₄, the potential of the sustain electrodes Sus(1)-Sus(n) is sustained at Vh(V), and the potential of the address electrodes Dat(1)-Dat(m) is sustained at 0(V). Also, a voltage having a slowly falling ramp waveform (from potential Vq(V) to Va(V) is applied to the scan electrodes Scn(1)-Scn(n).

In the selective reset period T₄, with the above-described reset operation, it is possible to generate weak reset discharges selectively in discharge cells in which sustain discharges were generated in the immediately preceding sub-field SF. These reset discharges attenuate the wall charges on the scan electrodes Scn and the sustain electrodes Sus, namely the wall charges on the surface of the protective layer 114 in the front panel 11, and adjust the wall charges on the address electrodes Dat, namely the wall charges on the surface of the phosphor layer 124, to the values appropriate for the address operation.

### 3-3. Address Period T₂

In the address period T₂, first the potential of the scan electrodes Scn(1)-Scn(n) is sustained at Vs(V). Then, an address pulse Pul.5 having amplitude Vw(V) is applied to the address electrode Dat(i), among the address electrodes Dat(1)-Dat(m), of the discharge cells to be displayed in the first row; and an address pulse Pul.4 of the negative polarity having amplitude Vb(V) is applied to the scan electrode Scn(1) in the first row. With this operation, the voltage at an intersection of the address electrode Dat(i) and the scan electrode Scn(1) becomes a sum of an externally applied voltage (Vw-Vb), a wall charge on the address electrode Dat(i), and a wall charge on the scan electrode Scn(1), the sum exceeding the firing voltage.

In the selected discharge cells, the above-described address discharge generates an address discharge between the address electrode Dat(i) and the scan electrode Scn(1) and between the scan electrode Scn(1) and the sustain electrode Sus(1), and forms a positive wall charge on the scan electrode Scn(1), a negative wall charge on the sustain electrode Sus(1), and a negative wall charge on the address electrode Dat(1). In this way, in the discharge cells to be displayed in the first row, the address discharge executes an address operation in which a wall charge is formed on each of the electrodes Scn(1), Sus(1), and Dat(i).

On the other hand, the voltage at intersections of the electrode Scn(1) and address electrodes to which the address pulse Pul.5 was not applied does not exceed the firing voltage, and the address discharge is not generated there. In the address period T₂, the above-described series of address operations is executed repeatedly in sequence to the n^{th} discharge cell, and the period ends.

### 3-4. Sustain Period T₃

In the sustain period T₃, first the potential of the sustain electrodes Sus(1)-Sus(n) is returned to 0(V). Then, a sustain pulse Pul.6 having amplitude Vm(V) is applied to the scan electrodes Scn(1)-Scn(n). With this operation, in the discharge cells in which the address discharge was generated, the voltage at an intersection of the scan electrode Scn(j) and the sustain electrode Sus(j) becomes a sum of the amplitude Vm (V) of the sustain pulse Pul.6, a wall charge on the scan electrode Scn(j), and a wall charge on the sustain electrode Sus(j), the sum exceeding the firing voltage. A sustain voltage is generated between the scan electrode Scn(j) and the sustain electrode Sus(j), a negative wall charge is reserved on the scan electrode Scn(j), and a positive wall charge is reserved on the sustain electrode Sus(j). In the stated discharge cells, a positive wall charge is reserved also on the address electrode Dat.

In the discharge cells in which the address discharge was not generated in the address period T₂, the sustain discharge is not generated even if the sustain pulse Pul.6 is applied. As a result, in these discharge cells, the wall charge state at the end of the reset period T₁ or T₄ is sustained.

After the above-described operation, the potential of the scan electrodes Scn(1)-Scn(n) is returned to 0(V), and a sustain pulse Pul.7 having amplitude Vm(V) is applied to the sustain electrodes Sus(1)-Sus(n). With this application, in the discharge cells in which the sustain discharge was generated by the application of the sustain pulse Pul.6 to the scan electrodes Scn(1)-Scn(n), the voltage between the scan electrode Scn(j) and the sustain electrode Sus(j) exceeds the firing voltage, and the sustain voltage is generated. It should be noted here that in the discharge cells in which the sustain discharge was not generated by the application of the sustain pulse Pul.6 to the scan electrodes Scn(1)-Scn(n), the sustain voltage is not generated in the present sub-field SF.

In the sustain period T₃, the application of the sustain pulse Pul.6 to the scan electrodes Scn(1)-Scn(n) and the application of the sustain pulse Pul.7 to the sustain electrodes Sus(1)-Sus(n) are repeated alternately, and the sustain discharge is generated continuously. The number of generations of the sustain discharge defines the brightness weight of each of the sub-fields SF₁ to SF_{X}.

It should be noted here that a what is called narrow width pulse is applied to between the scan electrodes Scn(1)-Scn(n) and the sustain electrodes Sus(1)-Sus(n). With this application of the narrow width pulse, the wall charges are erased from the upper surfaces of the scan electrodes Scn(1)-Scn(n) and the sustain electrodes Sus(1)-Sus(n), while sustaining the positive wall charge on the address electrode Dat(i).

### 4. Details of Waveforms of Voltages Applied to Electrodes Scn, Sus, and Dat in All-Cell Reset Period T₁

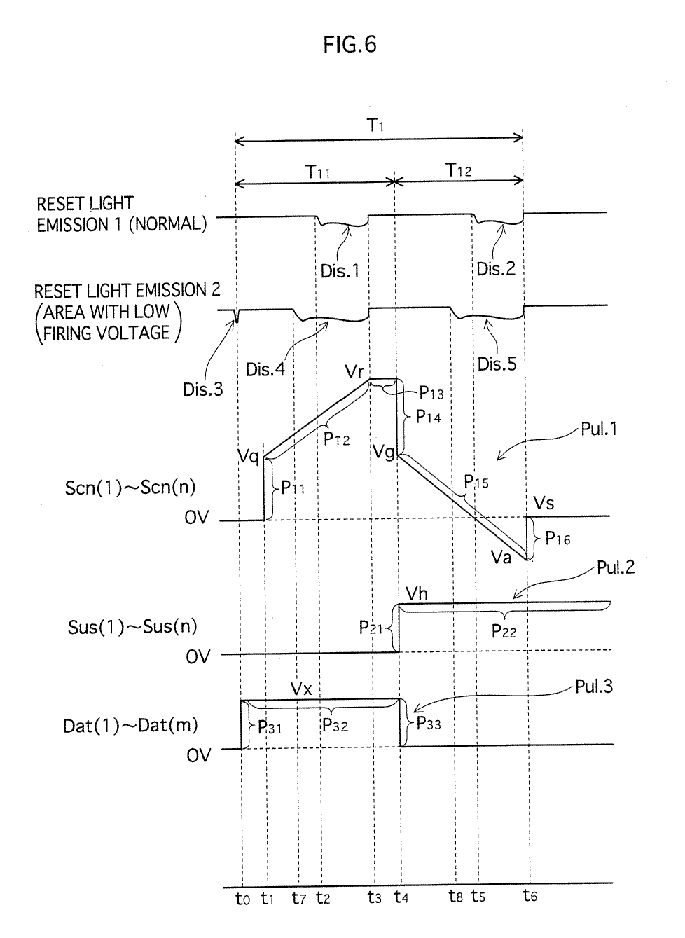

The following will describe in detail the all-cell reset period T₁, which is most characteristic in the method of driving the PDP device 1 of the present embodiment, with reference to FIG. 6.

As shown in FIG. 6, in the first step T₁₁ of the all-cell reset period T₁, while the potential of the sustain electrodes Sus(1)-Sus(n) is sustained at 0(V), a ramp waveform voltage is applied to the scan electrodes Scn(1)-Scn(n), and a rectangular wave pulse Pul.3 of the positive polarity is applied to the address electrodes Dat(1)-Dat(m). The drive method of the present embodiment is characterized by the timing at which the rectangular wave pulse Pul.3 is started to be applied to the address electrodes Dat(1)-Dat(m).

First, at timing t0 at the start of the first step T₁₁, a rising portion P31, in which the potential of the address electrodes Dat(1)-Dat(m) rapidly rises from 0(V) to Vx(V), is set. Then, after a certain interval, at timing t1, a rising portion P11, in which the potential of the scan electrodes Scn(1)-Scn(n) rapidly rises from 0(V) to Vq(V), is set. Then a rising ramp waveform portion P12, in which the potential slowly rises from Vq(V) to Vr(V), is set to the pulse Pul.1 that is applied to the scan electrodes Scn(1)-Scn(n).

In the areas in which the firing voltage is normal, namely, in the areas except for such areas that have a lower firing voltage than the other areas due to variation of a property in the panel surfaces or due to a long-term driving, or in the case where the voltage applied to the address electrodes Dat(1)-Dat(m) has not been increased to improve the resolution, a first reset discharge Dis.1 starts to be generated at timing t2, when a rising ramp waveform voltage P12 is being applied to the scan electrodes Scn(1)-Scn(n), and the first reset discharge Dis.1 continues to timing t3. It should be noted here that the first reset discharge Dis.1 that is generated in the first step T₁₁ is, as described above, a weak discharge in which the scan electrodes Scn(1)-Scn(n) are the anode and the sustain electrodes Sus(1)-Sus(n) and the address electrodes Dat(1)-Dat(m) are the cathode.

on the other hand, in the case where some areas have a lower firing voltage than the other areas, or in the case where the voltage applied to the address electrodes Dat(1)-Dat(m) has been increased to improve the resolution, a first reset discharge Dis.4 starts to be generated at timing t7, which precedes to timing t2 and when the rising ramp waveform voltage P12 is being applied to the scan electrodes Scn(1)-Scn(n). It should be noted here that a pulse Pul.3, which is applied to the address electrodes Dat(1)-Dat(m), is set to include a sustain portion P32 in which the potential is sustained at Vx(V) during the first step T₁₁.

The pulse Pul.1, which is applied to the scan electrodes Scn(1)-Scn(n), includes a sustain portion P13 in which the potential is sustained at Vr(V) for a time period between timing t3 and timing t4, and also includes a falling portion P14 in which the potential rapidly falls from Vr(V) to Vg(V) at the start of the second step T₁₂. At the start of the second step T₁₂, namely at timing t4, the potential of the address electrodes Dat(1)-Dat(m) rapidly falls from Vx(V) to 0(V) (falling portion P33), and the potential of the sustain electrodes Sus(1)-Sus(n) rapidly rises from 0(V) to Vh (V) (rising portion P21). It should be noted here that the potential of the pulse Pul.2, which was applied to the sustain electrodes Sus(1)-Sus(n) in the all-cell reset period T₁, is sustained at Vh(V) (sustain portion P22) until the address period T₂.

In the second period T₁₂ of the all-cell reset period T₁, a falling ramp waveform portion P15, in which the potential slowly falls from Vg(V) to Va(V) in a time period between timing t4 and timing t6, is set to the pulse Pul.1 that is applied to the scan electrodes Scn(1)-Scn(n). In the case where the firing voltage is normal, a second reset discharge Dis.2 is started from timing t5 which is in the middle of the falling ramp waveform portion P15. The second reset discharge Dis.2 ends at timing t6 when the potential of the scan electrodes Scn(1)-Scn(n) reaches Va(V) and when a rising portion P16, in which the potential of the scan electrodes Scn(1)-Scn(n) is returned to 0(V), is executed. Here, the second reset discharge Dis.2 is, as described above, a weak discharge in which the scan electrodes Scn(1)-Scn(n) are the cathode and the sustain electrodes Sus(1)-Sus(n) and the address electrodes Dat(1)-Dat(m) are the anode.

On the other hand, in the case where some areas have a lower firing voltage than the other areas, or in the case where the voltage applied to the address electrodes Dat(1)-Dat(m) has been increased to improve the resolution, a second reset discharge Dis.5 starts to be generated at timing t₈, which precedes to timing t₅ and when the falling ramp waveform voltage P15 is being applied to the scan electrodes Scn(1)-Scn(n), as is the case with the first reset discharge Dis.4 in the first step T₁₁.

### 5. Advantage of PDP Device 1 and Drive Method Thereof

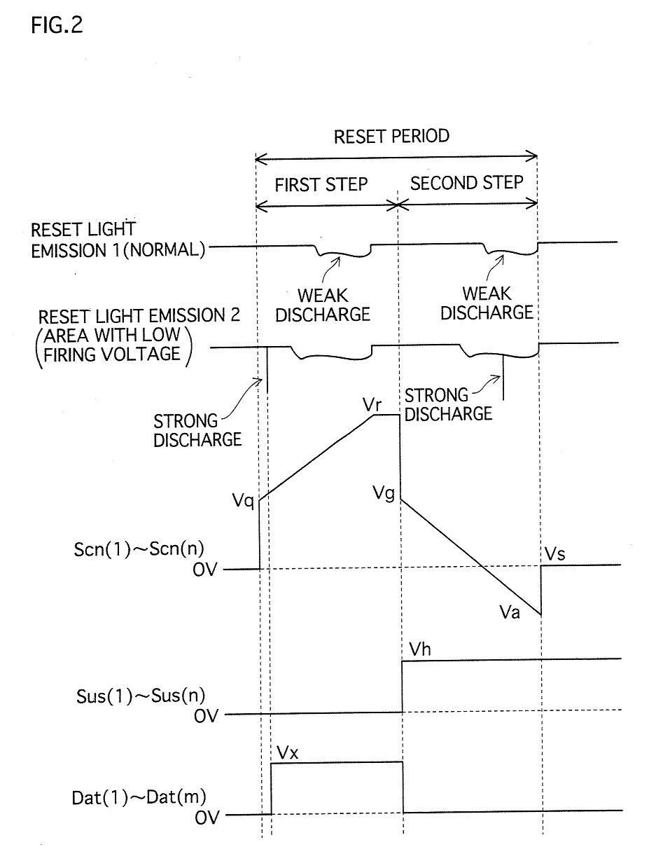

The advantage of the PDP device 1 in the present embodiment and the drive method thereof will be described in comparison with a drive method shown in FIG. 2 (the drive method of the improved conventional technology).

As described above, in the drive method of the improved conventional technology shown in FIG. 2, after the voltage Vq(V) is applied to the scan electrodes Scn(1)-Scn(n), the Vx(V) is applied to the address electrodes Dat(1)-Dat(m). With this construction, however, a discharge is generated between the sustain electrodes Sus(1)-Sus(n) and the address electrodes Dat(1)-Dat(m) by the Vx(V) applied to the address electrodes Dat(1)-Dat(m), in the case where some areas have a lower firing voltage than the other areas, or in the case where the voltage applied to the address electrodes Dat(1)-Dat(m) has been increased.

By the time this happens, the potential of the scan electrodes Scn(1)-Scn(n) has reached Vq(V). Therefore, the discharge generated between the sustain electrodes Sus(1)-Sus(n) and the address electrodes Dat(1)-Dat(m) becomes a trigger, extends to the scan electrodes Scn(1)-Scn(n), and develops into a strong discharge in the discharge cells.

That is to say, although the improved conventional technology provides an advantageous effect of preventing an accidental generation of a strong discharge during the all-cell reset period in the case where there is no variation in the firing voltage in the panel unit, the Vx(V) applied to the address electrodes Dat(1)-Dat(m) induces a strong discharge in the case where some areas have a lower firing voltage than the other areas due to variation of a property in the panel surfaces or due to a long-term driving, or in the case where the voltage applied to the address electrodes Dat(1)-Dat(m) has been increased to improve the resolution.

On the other hand, by the drive method of the PDP device 1 in the present embodiment, as shown in FIG. 6, the pulse Pul.3 is applied to the address electrodes Dat(1)-Dat(m) at timing to, namely, at the timing prior to timing t1 at which the potential of the scan electrodes Scn(1)-Scn(n) rapidly rises from 0(V) to Vq(V). With this construction of the drive method of the present embodiment shown in FIG. 6, no potential difference is generated between the sustain electrodes Sus(1)-Sus(n) and the address electrodes Dat(1)-Dat(m) at timing t0 at which the voltage Vx(V) is applied to the address electrodes Dat(1)-Dat(m) to generate discharge Dis.3. Accordingly, in the drive method of the present embodiment, the discharge Dis.3 generated between the address electrodes Dat(1)-Dat(m) and the sustain electrodes Sus(1) neither becomes a trigger nor develops into the scan electrodes Scn(1)-Scn(n).

Furthermore, in the drive method of the present embodiment, the pulse Pul.3 of the positive polarity is applied to the address electrodes Dat(1)-Dat(m) in the first step T₁₁ of the all-cell reset period T₁. This construction provides a stable reset discharge, as is the case with the improved conventional technology.

As described above, the PDP device 1 and the drive method thereof in the present embodiment prevents a not-desired, strong discharge from being generated during the all-cell reset period T₁, and thus ensures a high-quality image performance even in the case where some areas have a lower firing voltage than the other areas, or in the case where the voltage applied to the address electrodes Dat(1)-Dat(m) has been increased to improve the resolution.

It should be noted here that in the drive method of the PDP device 1 in the present embodiment, it is preferable that the amplitudes Vx(V) and Vw(V) of the pulses Pul.3 and Pul.5 that are respectively applied to the address electrodes Dat(1)-Dat(m) are set to be the same value, in terms of ensuring the simplicity in the number of power sources and in relation to this, ensuring the simplicity of the circuit structure, although these amplitudes are not necessarily be set to the same value.

### 6. Steps Performed by Display Drive Unit 20 in All-Cell Reset Period T₁

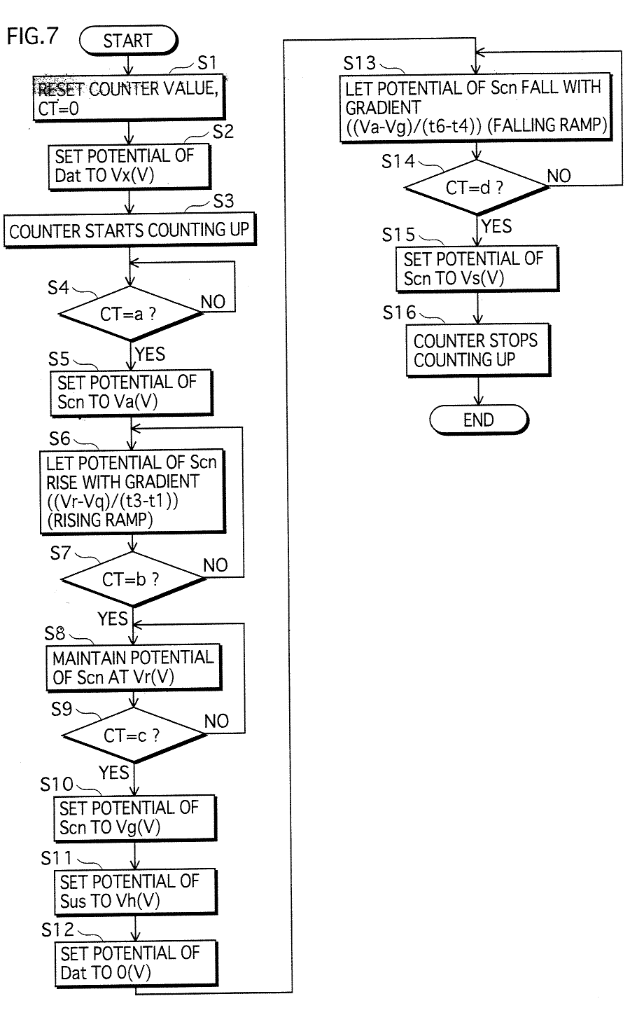

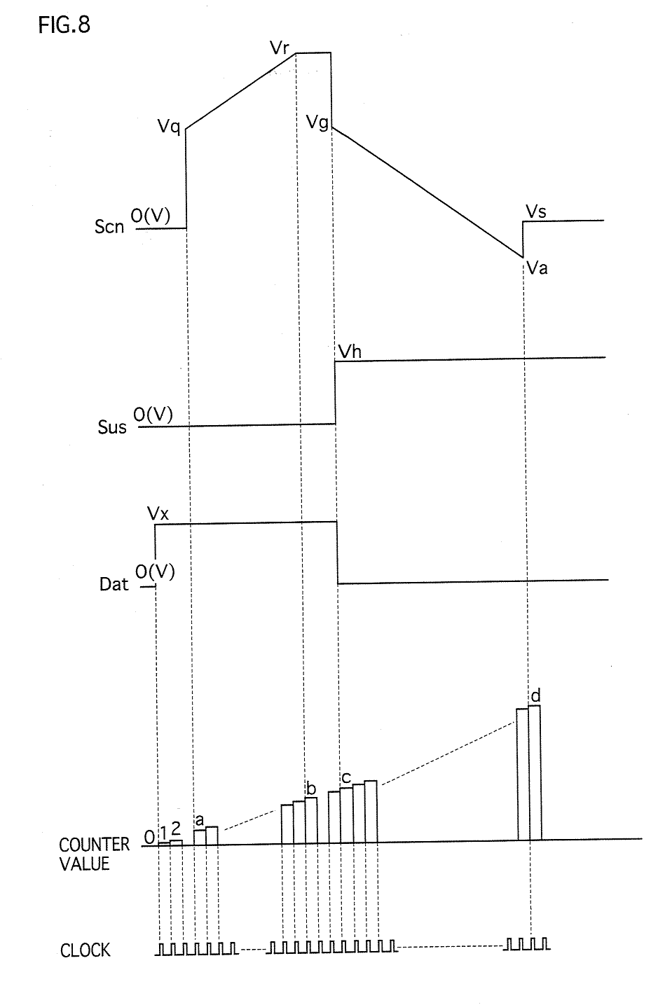

The following will describe the drive control process that is performed by the display drive unit 20 onto the panel unit 10 during the all-cell reset period T₁, with reference to FIGS. 7 and 8.

It should be noted first that the timing generating unit 24 includes a clock pulse unit CLK and a counter unit whose illustration is omitted in FIG. 4, where the clock pulse unit CLK provides narrow-width clock pulses that are shorter in the interval than the difference between adjacent timings of the timings t0 to t8, and the counter unit adds up the clock pulses provided by the clock pulse unit CLK.

As shown in FIG. 7, in the drive control during the all-cell reset period T₁, a counter value CT of the counter unit is reset (step S1). At the same time, the potential of the address electrodes Dat(1)-Dat(m) is set to Vx(V) (step S2).

Then the counter unit starts counting up the counter value CT (step S3), and continues the counting up until the counter value CT reaches “a” (NO in step S4). When the counter value CT=a (corresponding to timing t1 shown in FIG. 6), the potential of the scan electrodes Scn(1)-Scn(n) is set to Vq(V) (step S5).

As shown in FIG. 8, the potential of the scan electrodes Scn(1)-Scn(n) is risen from 0(V) to Vq(V) at timing t1 when the counter value CT=a.

Back to FIG. 7, the voltage is started to be increased with a positive slant ((Vr-Vq)/(t3-t1)) from timing t1 at which the potential of the scan electrodes Scn(1)-Scn(n) has reached Vq(V) (step S6). The waveform of this portion is shown in FIG. 8 as a slant portion corresponding to a time period in which the potential changes from Vq(V) to Vr(V). At timing t3 when the counter value CT=c (YES in step S9), the potential of the scan electrodes Scn(1)-Scn(n) is caused to fall from Vr(V) to Vg(V) (step S10). At the same time, or substantially at the same time, the potential of the sustain electrodes Sus(1)-Sus(n) is risen to Vh (V) (step S11), and the potential of the address electrodes Dat(1)-Dat(m) is caused to fall to 0(V) (step S12).

Next, as shown in FIG. 7, the potential of the scan electrodes Scn(1)-Scn(n) is caused to fall with a negative slant ((Va-Vg)/(t6-t4)) (step S13). The falling ramp waveform portion in the pulse Pul.1 applied to the scan electrodes Scn(1)-Scn(n) continues until the counter value CT=d (NO in step S14). The falling ramp waveform portion corresponds to the portion shown in FIG. 8 in which the potential slowly falls from Vg(V) to Va(V).

At timing t6 when the counter value CT=d (YES in step S14), the potential of the scan electrodes Scn(1)-Scn(n) is set to Vs(V) (step S15), the counting up is stopped (step S16), and the control process in the all-cell reset period T₁ ends.

7. Setting Sub-Fields SF with all-Cell Reset Period T₁

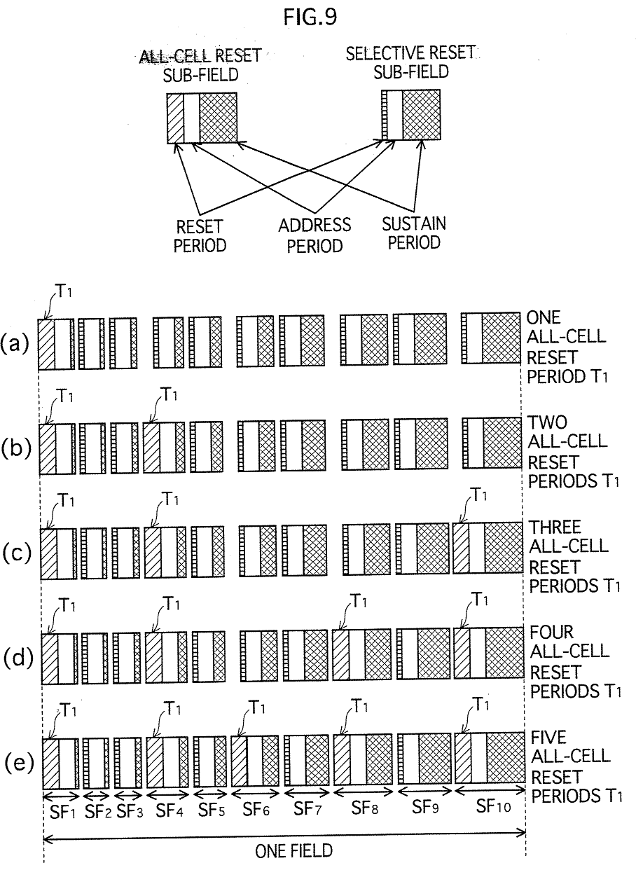

Next, how the drive method of the present embodiment sets the sub-fields SF in one field will be described with reference to FIG. 9. FIG. 9 shows the construction of the sub-fields SF in one field for driving the PDP device 1. It is presumed in FIG. 9 that one field is composed of 10 sub-fields SF₁ to SF₁₀.

In driving the PDP device 1 of the present embodiment, the construction of the sub-fields SF is defined based on the data on the APL detected by the APL detecting unit 28. In driving the PDP device 1, one field is constructed to include at least one sub-field that includes the all-cell reset period T₁, and one sub-field that includes the selective reset period T₄. It is determined based on the APL data to which portions of one field, sub-fields including the all-cell reset period T₁ should be assigned.

FIG. 9(a) shows the construction of the sub-fields SF₁ to SF₁₀ that is applied when the APL value is in the range from 0[%] to 1.5[%]. More specifically, in this construction, only the first sub-field SF₁ includes the all-cell reset period T₁ and each of the second sub-field SF₂ to the tenth sub-field SF₁₀ includes the selective reset period T₄.

Similarly, as shown in FIG. 9(b), in the construction of the sub-fields that is applied when the APL value is in the range from 1.5[%] to 5[%], the first sub-field SF₁ and the fourth sub-field SF₄ include the all-cell reset period T₁, and each of the remaining sub-fields SF includes the selective reset period T₄. Also, as shown in FIG. 9(c), in the construction of the sub-fields that is applied when the APL value is in the range from 5[%] to 10[%] the first sub-field SF₁, the fourth sub-field SF₄, and the tenth sub-field SF₁₀ include the all-cell reset period T₁.

Also, as shown in FIG. 9(d), in the construction of the sub-fields that is applied when the APL value is in the range from 10[%] to 15[%], the first sub-field SF₁, the fourth sub-field SF₄, the eighth sub-field SF₈, and the tenth sub-field SF₁₀ include the all-cell reset period T₁. And as shown in FIG. 9(e), in the construction of the sub-fields that is applied when the APL value is in the range from 15[%] to 100[%], the first sub-field SF₁, the fourth sub-field SF₄, the sixth sub-field SF₆, the eighth sub-field SF₈, and the tenth sub-field SF₁₀ include the all-cell reset period T₁.

As described above, in the drive method of the PDP device 1 in the present embodiment, the number of sub-fields SF including the all-cell reset period T₁ is determined based on the APL value detected by the APL detecting unit 28 (see FIG. 4). It should be noted here that when the APL value is high in a field, which indicates that the image has a narrow black display area, the drive method of the present embodiment increases the number of sub-fields SF including the all-cell reset period T₁. This construction makes it possible to increase the amount of priming to stabilize the discharge.

On the other hand, when the APL value is low, which indicates that the image has a wide black display area, the drive method of the present embodiment decreases the number of sub-fields SF including the all-cell reset period T₁. This construction makes it possible to ensure a high-quality black display.

With the above-described drive method of the PDP device 1 in the present embodiment, it is possible to display an image with high contrast even if the image includes a highly bright area, since the brightness of the black display area is low in correspondence with a low APL value.

Also, according to the drive method of the present embodiment, in the all-cell reset period T₁, the Vx(V) is applied to the address electrodes Dat(1)-Dat(m) prior to timing t1 at which a voltage is applied to the scan electrodes Scn(1)-Scn(n). As a result, as described above, it is possible to generate the initial discharge in a stable manner even in the case where some areas of the panel surfaces have a lower firing voltage than the other areas due to variation of a property in the panel surfaces or due to along-term driving, or in the case where the voltage applied to the address electrodes Dat(1)-Dat(m) has been increased to improve the resolution.

Further, in the PDP device 1 of the present embodiment, the following phosphor materials are selectively used for the phosphor layers 124R, 124G, and 124B in the panel unit 10. It has been confirmed that the generation of an erroneous discharge (strong discharge) in the all-cell reset period T₁ becomes prominent especially when the phosphor layers 124R, 124G, and 124B includes phosphor materials that are easy to charge negatively when the panel is driven, such as Y₂O₃:Eu, Zn₂SiO₄:Mn, and CaMgSi₂O₆:Eu among the phosphor materials described earlier. However, the drive method of the present embodiment effectively suppresses the generation of the erroneous discharge in the all-cell reset period T₁ even in the case where the phosphor layers 124R, 124G, and 124B includes such phosphor materials that are easy to charge negatively.

Although FIG. 9 shows an example in which there are five patterns of arranging sub-fields SF including the all-cell reset period T₁ in one field. The present invention is not limited to this, but can be varied, for example, as follows.

### <Variation 1>

The following Table 1 shows an example in which there are four patterns of arranging sub-fields SF including the all-cell reset period T₁ in one field, based on the APL value.

TABLE 1

| | | Sub-fields including all-cell reset period (◯: including, —: | | | | | | | | | |
|---|---|---|---|---|---|---|---|---|---|---|---|
| | Number of | not including) | | | | | | | | | |
| APL(%) | all-cell resets | SF1 | SF2 | SF3 | SF4 | SF5 | SF6 | SF7 | SF8 | SF9 | SF10 |
| 0-1.5 | 1 | ◯ | — | — | — | — | — | — | — | — | — |
| 1.5-5 | 2 | ◯ | — | — | — | — | — | — | — | ◯ | — |
| 5-10 | 3 | ◯ | — | — | ◯ | — | — | — | — | ◯ | — |
| 10-100 | 4 | ◯ | — | — | ◯ | — | — | — | ◯ | — | ◯ |

As shown in Table 1, according to the sub-field setting method of this variation, sub-fields SF including the all-cell reset period T₁ are assigned to four sub-fields in one field, based on the APL value. More specifically, when the APL value is in the range from 0[%] to 1.5[%], only the first sub-field SF₁ includes the all-cell reset period T₁ and each of the remaining sub-fields SF₂ to SF₁₀ includes the selective reset period T₄. Similarly, when the APL value is in the range from 1.5[%] to 5[%], the first sub-field SF₁ and the ninth sub-field SF₉ include the all-cell reset period T₁. Also, when the APL value is in the range from 5[%] to 10[%], the first sub-field SF₁, the fourth sub-field SF₄, and the ninth sub-field SF₉ include the all-cell reset period T₁. Also, when the APL value is in the range from 10[%] to 100[%], the first sub-field SF₁, the fourth sub-field SF₄, the ninth sub-field SF₉, and the tenth sub-field SF₁₀ include the all-cell reset period T₁.

When the above-described method of the present variation is used to assign the sub-fields including the all-cell reset period T₁, the same advantageous effect, which is obtained by the method shown in FIG. 9, is obtained.

### <Variation 2>

The following Table 2 shows an example in which there are three patterns of arranging sub-fields SF including the all-cell reset period T₁ in one field, based on the APL value.

TABLE 2

| | | Sub-fields including all-cell reset period (◯: including, —: | | | | | | | | | |
|---|---|---|---|---|---|---|---|---|---|---|---|
| | Number of | not including) | | | | | | | | | |
| APL(%) | all-cell resets | SF1 | SF2 | SF3 | SF4 | SF5 | SF6 | SF7 | SF8 | SF9 | SF10 |
| 0-1.5 | 1 | ◯ | — | — | — | — | — | — | — | — | — |
| 1.5-5 | 2 | ◯ | — | — | ◯ | — | — | — | — | — | — |
| 5-100 | 3 | ◯ | — | — | ◯ | — | ◯ | — | — | — | — |

As shown in Table 2, according to the sub-field setting method of this variation, when the APL value is in the range from 0[%] to 1.5[%], only the first sub-field SF₁ includes the all-cell reset period T₁. Also, when the APL value is in the range from 1.5[%] to 5[%], the first sub-field SF₁ and the fourth sub-field SF₄ include the all-cell reset period T₁. Also, when the APL value is in the range from 5[%] to 100[%], the first sub-field SF₁, the fourth sub-field SF₄, and the sixth sub-field SF₆ include the all-cell reset period T₁. In this variation, sub-fields SF including the all-cell reset period T₁ are assigned to the sub-fields that are closer to the start of the field.

With the above-described construction in which sub-fields SF including the all-cell reset period T₁ are assigned to the sub-fields that are closer to the start of the field, the following advantage is obtained.

During a sub-field to which a large number of sustain discharges are assigned, a cross talk is easy to occur between a discharge cell, in which the large number of sustain discharges are generated, and an adjacent discharge cell. When this happens, the adjacent discharge cell is influenced by the cross talk, the wall charge is reduced therein, and fails to generate an address discharge in the succeeding sub-field, resulting in a deterioration of image. The image deterioration becomes prominent especially when a sub-field with a low grayscale level is influenced by the cross talk.

For the above-stated reason, in general, the all-cell reset period is assigned to the sub-fields closer to the start of the field that have lower grayscale levels when a PDP is driven. With this, it is ensured that the wall charge state in the discharge cell is reset even if it is influenced by the cross talk that occurred to the sub-field immediately before. When this fact is taken into account, it is apparent that the sub-field assignment method shown in Table 2 makes it possible to restrict an address defect caused by a cross talk, restricting the image deterioration in a reliable manner.

### Embodiment 2

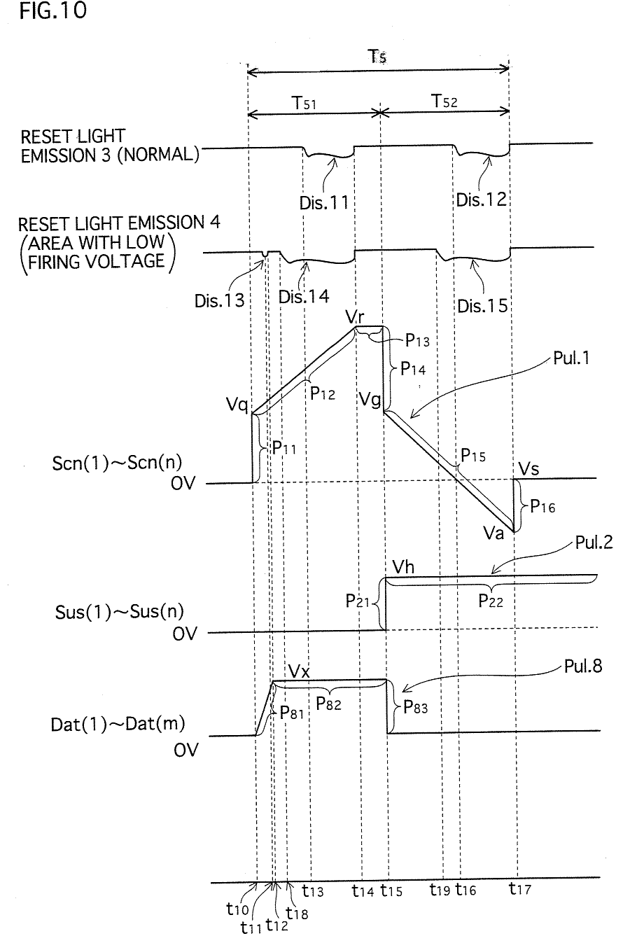

A drive method of a PDP device in Embodiment 2 will be described with reference to FIG. 10. FIG. 10 is a waveform diagram showing waveforms of the voltages applied to the scan electrodes Scn(1)-Scn(n), the sustain electrodes Sus(1)-Sus(n), and the address electrodes Dat(1)-Dat(m) during the all-cell reset period T₅, corresponding to a part of the drive method of the PDP device in Embodiment 2.

The PDP device of the present embodiment has the same construction as the PDP device 1 in Embodiment 1, and the drive method of the present embodiment is the same as the method shown in FIG. 5 of Embodiment 1, except for the all-cell reset period T₅. Therefore, most of the description of the device and method is omitted here, and the following description will focus on the all-cell reset period T₅.

As shown in FIG. 10, in the drive method of the present embodiment, the pulses Pul.1 and Pul.2, which are respectively applied to the scan electrodes Scn(1)-Scn(n) and to the sustain electrodes Sus(1)-Sus(n) during the all-cell reset period T₅, have the same waveforms as in the drive method of Embodiment 1. The drive method of the present embodiment is characterized by the waveform of a pulse Pul.8 that is applied to the address electrodes Dat(1)-Dat(m), and the timing (timing t10) at which the pulse Pul.8 starts to be applied.

At timing t10, a rising portion P81 of the pulse Pul.8 applied to the address electrodes Dat(1)-Dat(m) is started, and at the same time, the rising portion P11 of the pulse Pul.1 applied to the scan electrodes Scn(1)-Scn(n) is started. The rising portion P81 of the pulse Pul.8 has a ramp waveform with a positive slant (Vx/(t12-t10)). It is presumed here that the slant of the rising portion P81 is set to be smaller than the slant of the rising portion of the pulse Pul.5 applied in the address period T₂ (see FIG. 5).

A sustain portion P82 and falling portion P83 of the pulse Pul.8 are the same as those in Embodiment 1.

In the drive method of the present embodiment, in the case where there is no such areas that have a lower firing voltage than the other areas, a first reset discharge Dis.11 starts to be generated at timing t13 when the rising ramp waveform voltage P12 is being applied to the scan electrodes Scn(1)-Scn(n) as the pulse Pul.1, and a second reset discharge Dis.12 starts to be generated at timing t16 when the falling ramp waveform voltage P15 is being applied.

On the other hand, in the case where some areas have a lower firing voltage than the other areas due to variation of a property in the panel surfaces or due to a long-term driving, a discharge Dis.13 may be generated between the sustain electrodes Sus(1)-Sus(n) at timing t11, which is in the middle of the rising portion P81, induced by the application of the pulse Pul.8 to the address electrodes Dat(1)-Dat(m), in the first step T₅₁ of the all-cell reset period T₅. However, the discharge Dis.13 is a weak discharge, not a strong discharge, since the rising portion P81 has the above-described slant. As a result, even if the pulses Pul.1 and Pul.8 are applied to both the scan electrodes Scn(1)-Scn(n) and the address electrodes Dat(1)-Dat(m) simultaneously at timing t10, such a discharge that develops into the scan electrodes Scn(1)-Scn(n) is not induced by the application of the pulse Pul.8. Accordingly, with the drive method of the present embodiment, even if the discharge Dis.13 is generated by the application of the pulse Pul.8 in the areas having a lower firing voltage than the other areas, no erroneous discharge is generated, and second discharges Dis.14 and Dis.15 are generated.

As apparent from the above description, the PDP device and the drive method thereof in the present embodiment provide the same advantage as the PDP device and the drive method thereof in Embodiment 1. Further, it is possible to reduce the device cost if the amplitude Vx(V) of the pulse Pul.8 is set to the same value as the amplitude Vm(V) of the pulse Pul.5 in the address period T₂.

In the drive method of the present embodiment, the potential of the address electrodes Dat(1)-Dat(m) is set to Vx(V) after the potential of the scan electrodes Scn(1)-Scn(n) changes to Vq(V). This construction eliminates the need to ensure an excessive amount of withstanding voltage for the address driver 21 in relation to the wringing by the potential change. Accordingly, it is possible for the PDP device of the present embodiment to reduce the device cost more than the PDP device 1 of Embodiment 1.

In the present embodiment, as is the case with Embodiment 1, it is possible to set the sub-fields SF including the all-cell reset period T₅, based on the APL value detected by the APL detecting unit 28.

### <Others>

The construction, acts and effects of the present invention have been described through two embodiments up to now. However, the present invention is not limited to these embodiments. For example, in the above-described embodiment, the pulse Pul.1 and the pulse Pul.8 are simultaneously started to be applied respectively to the scan electrodes Scn(1)-Scn(n) and the address electrodes Dat(1)-Dat(m), at timing t10. However, the pulses need not be applied simultaneously. That is to say, the pulse Pul.8 may be applied at a timing prior to timing t1 when the pulse Pul.1 starts to be applied, with the same slant of the rising portion P81 of the pulse Pul.8, as is the case with the drive method of Embodiment 1.

In the case where the pulse Pul.8 starts to be applied at a timing prior to a timing when the pulse Pul.1 starts to be applied, the slant of the rising portion P81 may be set to be equal to or larger than the slant of the rising portion of the pulse Pul.5. In this case, as is the case with Embodiment 1, it is possible to restrict erroneous discharges from occurring in the all-cell reset period, by applying the pulse Pul.8 at a timing prior to the timing when the pulse Pul.1 starts to be applied.

The amplitude Vx(V) of the pulses Pul.3 and Pul.8 in the all-cell reset periods T₁ and T₅ and the amplitude Vw(V) of the pulse Pul.5 in the address period T₂ may not necessarily be set as the same value.

The device construction is not limited to the construction shown in FIG. 4, but may be a construction which includes a time measuring unit that counts the device drive time and outputs the measured time data to the timing generating unit 24. This construction makes it possible to control the amplitude Vx(V) of the pulses Pul.3 and Pul.8 based on the time data sent from the time measuring unit. For example, it is possible to make the reset discharge more stable by setting the amplitude Vx(V) to become greater as the driving time period becomes longer. It should be noted here that this construction provides a fine-grained control regardless of whether the driving time period is defined based on the total light-emission time period, or based on the time period from a power on to a power off, or based on both time periods.

In the above-described embodiment, the all-cell reset periods T₁ and T₅ are performed using the address electrodes Dat in the back panel 12. However, the target of the application of the pulses Pul.3 and Pul.8 is not limited to the address electrodes Dat. For example, the fourth electrode, which is different from the address electrodes Dat, may be provided in the back panel 12, and the pulses Pul.3 and Pul.8 may be applied to the fourth electrode. This construction increases the degree of freedom in controlling the wall charge distribution state in the all-cell reset periods T₁ and T₅.

In the above-described embodiment, the amplitude of the waveform of the voltage applied to the address electrodes Dat(1)-Dat(m) in the first steps T₁₁ and T₅₁ of the all-cell reset periods T₁ and T₅ is set based on at least one of the drive time period and the panel temperature. However, the following settings are also available.

According to the PDP device and the drive method thereof of the present invention, the waveform of the voltage applied to the address electrodes Dat(1)-Dat(m) in the first steps T₁₁ and T₅₁ of the all-cell reset periods T₁ and T₅ may be set such that a timing at which the potential changes in the waveform is set based on at least one of the drive time period and the panel temperature. Also, according to the PDP device and the drive method thereof of the present invention, the waveform of the voltage applied to the address electrodes Dat(1)-Dat(m) in the first steps T₁₁ and T₅₁ of the all-cell reset periods T₁ and T₅ may be set such that the waveform includes a timing at which waveform becomes “High” in accordance with the APL. Further, according to the PDP device and the drive method thereof of the present invention, the amplitude of the waveform of the voltage applied to the address electrodes Dat(1)-Dat(m) in the first steps T₁₁ and T₅₁ of the all-cell reset periods T₁ and T₅ may be set in accordance with the APL.

The present invention can be applied to a PDP device having a resolution that is equal to or higher than HD (High Definition). As described above, even with such a high resolution, the present invention can restrict a discharge from occurring when the potential of the address electrodes Dat(1)-Dat(m) in the all-cell reset period is “High”. This produces an advantageous effect of preventing flickers from appearing in the areas having low grayscale levels. Here, display panels having a resolution that is equal to or higher than HD (High Definition) include, for example, the following:

For 37-inch panels: panels having a resolution higher than HD panels with 1024×720 (pixels);

For 42-inch panels: panels having a resolution higher than HD panels with 1024×768 (pixels); and

For 50-inch panels: panels having a resolution higher than HD panels with 1366×768 (pixels).

The display panels having a resolution that is equal to or higher than HD also include full HD panels (1920×1080 (pixels)).

Other than the above-described materials, the phosphor layers 124R, 124G, and 124B may be made of, for example, the following phosphors, respectively.

R phosphor: (Y,Gd)BO₃:Eu

G phosphor: mixture of (Y,Gd)BO₃:Tb and Zn₂SiO₄:Mn

B phosphor: BaMg₂Al₁₄O₂₄:Eu

### INDUSTRIAL APPLICABILITY

The present invention is applicable to display devices, such as television displays and computer monitors, that require high definition and high quality.

1. A drive method of a plasma display panel device which includes a panel unit in which a plurality of pairs of first electrode and second electrode are arranged and also a plurality of third electrodes are arranged to intersect the first and second electrode pairs with a discharge space therebetween, discharge cells being provided in one-to-one correspondence with three-dimensional intersections of the third electrodes and the first and second electrode pairs, wherein each field in a time domain is divided into a plurality of brightness-weighted sub-fields and includes an all-cell reset period in which all of the discharge cells are reset with respect to wall charge state, wherein
the all-cell reset period is divided into a period first step and a period second step, a voltage having a ramp waveform with a positive slant is applied to first electrodes in the period first step to generate a first reset discharge, and a voltage having a ramp waveform with a negative slant is applied to the first electrodes in the period second step to generate a second reset discharge, and
a voltage having a waveform of a positive polarity relative to second electrodes is applied to the third electrodes in the period first step at a timing prior to generation of the first reset discharge.

2. The plasma display panel device drive method of claim 1, wherein
the waveform of the voltage applied to the third electrodes in the period first step includes a rising ramp waveform portion with a positive slant.

3. The plasma display panel device drive method of claim 2, wherein
each of the plurality of sub-fields includes:
an address period in which an address discharge is generated in selected discharge cells by applying a voltage between the first electrodes and the third electrodes; and
a sustain period in which a voltage is applied between electrodes in each pair in all the discharge cells so that a sustain discharge is generated in the selected discharge cells in which the address discharge was generated, and
a slant of the rising ramp waveform portion in the waveform of the voltage applied to the third electrodes in the period first step is set to be slower than a slant of a rising portion in a waveform of the voltage applied to the third electrodes in the address period.

4. The plasma display panel device drive method of claim 2, wherein
in the period first step, the rising ramp waveform portion in the waveform of the voltage applied to the third electrodes is set to start at a timing prior to a timing at which a rising portion in the waveform of the voltage applied to the first electrodes starts.

5. The plasma display panel device drive method of claim 4, wherein
the timing at which the rising ramp waveform portion in the waveform of the voltage applied to the third electrodes starts is set with a predetermined time period before the timing at which the rising portion in the waveform of the voltage applied to the first electrodes starts such that even if a discharge is generated between the third electrodes and the second electrodes by the application of the voltage to the third electrodes, an influence of the discharge generated between the third electrodes and the second electrodes attenuates within the predetermined time period.

6. The plasma display panel device drive method of claim 1, wherein
at a timing when the period second step starts, a voltage starts to be applied to second electrodes, and a falling portion in the waveform of the voltage applied to the third electrodes starts.

7. The plasma display panel device drive method of claim 1, wherein
with respect to the waveform of the voltage applied to the third electrodes in the period first step, an amplitude of the waveform is set based on at least one of a drive time period and a panel temperature.

8. The plasma display panel device drive method of claim 1, wherein
with respect to the waveform of the voltage applied to the third electrodes in the period first step, a timing at which a potential changes is set based on at least one of a drive time period and a panel temperature.

9. The plasma display panel device drive method of claim 1, wherein
with respect to the waveform of the voltage applied to the third electrodes in the period first step, a timing at which the voltage having the waveform of the positive polarity relative to the second electrodes is set in accordance with an average picture level.

10. The plasma display panel device drive method of claim 1, wherein
with respect to the waveform of the voltage applied to the third electrodes in the period first step, an amplitude of the waveform is set in accordance with an average picture level.

11. The plasma display panel device drive method of claim 1, wherein
with respect to the panel unit, a size of the discharge cells is defined such that a resolution higher than HD is achieved.

12. The plasma display panel device drive method of claim 1, wherein
each field is composed of one or more first sub-fields that include the all-cell reset period and one or more second sub-fields that do not include the all-cell reset period, and
a ratio of the first sub-fields to one field is determined in accordance with an average picture level for an image corresponding to said one field.

13. A plasma display panel device comprising a panel unit and a drive unit, the panel unit including a plurality of pairs of first electrode and second electrode and a plurality of third electrodes that are arranged to intersect each other with a discharge space therebetween, discharge cells being provided in one-to-one correspondence with three-dimensional intersections of the first and second electrode pairs and the third electrodes, and the drive unit drives the panel unit to perform a display by a method in which each field in a time domain is divided into a plurality of brightness-weighted sub-fields and includes an all-cell reset period in which all of the discharge cells are reset with respect to wall charge state, wherein
the all-cell reset period is divided into a period first step and a period second step, a voltage having a ramp waveform with a positive slant is applied to first electrodes in the period first step to generate a first reset discharge, and a voltage having a ramp waveform with a negative slant is applied to the first electrodes in the period second step to generate a second reset discharge, and
the drive unit applies a voltage, which has a waveform of a positive polarity relative to second electrodes, to the third electrodes in the period first step at a timing prior to generation of the first reset discharge.

14. The plasma display panel device of claim 13, wherein
in the drive performed by the drive unit,
the waveform of the voltage applied to the third electrodes in the period first step includes a rising ramp waveform portion with a positive slant.

15. The plasma display panel device of claim 14, wherein
in the drive performed by the drive unit,
each of the plurality of sub-fields includes:
an address period in which an address discharge is generated in selected discharge cells by applying a voltage between the first electrodes and the third electrodes; and
a sustain period in which a voltage is applied between electrodes in each pair in all the discharge cells so that a sustain discharge is generated in the selected discharge cells in which the address discharge was generated, and
a slant of the rising ramp waveform portion in the waveform of the voltage applied to the third electrodes in the period first step is set to be slower than a slant of a rising portion in a waveform of the voltage applied to the third electrodes in the address period.

16. The plasma display panel device of claim 14, wherein
in the drive performed by the drive unit,
in the period first step, the rising ramp waveform portion in the waveform of the voltage applied to the third electrodes is set to start at a timing prior to a timing at which a rising portion in the waveform of the voltage applied to the first electrodes starts.

17. The plasma display panel device of claim 16, wherein
in the drive performed by the drive unit,
the timing at which the rising ramp waveform portion in the waveform of the voltage applied to the third electrodes starts is set with a predetermined time period before the timing at which the rising portion in the waveform of the voltage applied to the first electrodes starts such that even if a discharge is generated between the third electrodes and the second electrodes by the application of the voltage to the third electrodes, an influence of the discharge generated between the third electrodes and the second electrodes attenuates within the predetermined time period.

18. The plasma display panel device of claim 13, wherein
in the drive performed by the drive unit,
at a timing when the period second step starts, a voltage starts to be applied to second electrodes, and a falling portion in the waveform of the voltage applied to the third electrodes starts.

19. The plasma display panel device of claim 13, wherein
in the drive performed by the drive unit,
an amplitude of the waveform of the voltage applied to the third electrodes in the period first step is set based on at least one of a drive time period and a panel temperature.

20. The plasma display panel device of claim 13, wherein
in the drive performed by the drive unit,
a timing at which a potential changes in the waveform of the voltage applied to the third electrodes in the period first step is set based on at least one of a drive time period and a panel temperature.

21. The plasma display panel device of claim 13, wherein
in the drive performed by the drive unit,
with respect to the waveform of the voltage applied to the third electrodes in the period first step, a timing at which the voltage having the waveform of the positive polarity relative to the second electrodes is set in accordance with an average picture level.

22. The plasma display panel device of claim 13, wherein
in the drive performed by the drive unit,
an amplitude of the waveform of the voltage applied to the third electrodes in the period first step is set in accordance with an average picture level.

23. The plasma display panel device of claim 13, wherein
with respect to the panel unit, a size of the discharge cells is defined such that a resolution higher than HD is achieved.

24. The plasma display panel device of claim 13, wherein
in the drive performed by the drive unit,
each field is composed of one or more first sub-fields that include the all-cell reset period and one or more second sub-fields that do not include the all-cell reset period, and
a ratio of the first sub-fields to one field is determined in accordance with an average picture level for an image corresponding to said one field.

25. The plasma display panel device of claim 13, wherein
a discharge gas that contains at least xenon is filled in the discharge space, and
a ratio of the xenon to the discharge gas in pressure is 7% or more.
